(19) United States
(12) Patent Application Publication
(10) Pub. No.: US 2023/0229834 A1
(43) Pub. Date: Jul. 20, 2023

(54) METHOD FOR DETERMINING AT LEAST ONE PRODUCTION PARAMETER

(71) Applicant: Heraeus Amloy Technologies GmbH, HANAU (DE)

(72) Inventors: Hans Jürgen WACHTER, Hanau (DE); Eugen MILKE, Hanau (DE); Hamed SHAKUR SHAHABI, Hanau (DE)

(21) Appl. No.: 18/001,183

(22) PCT Filed: Jun. 2, 2021
(86) PCT No.: PCT/EP2021/064741

§ 371 Date: Dec. 8, 2022

(30) Foreign Application Priority Data
Jun. 9, 2020 (EP) 20179001.1

(51) Int. Cl. G06F 30/27; B29C 45/78

(52) U.S. Cl. CPC G06F 30/27; B29C 45/78; G06F 2113/22

(57) ABSTRACT

An inlet screen, arranged at the water inlet of a hydropower plant and comprises a plurality of elongated bars separated by a distance holding means, each elongated bar having in its elongation a proximal portion and a distal portion, and an upstream region and a downstream region, said regions being at an angle in relation to said proximal and distal portions, at least one of said bars defining a space extending along at least a portion of the elongation of said bar, said bar being provided. with an electric heating means. Said elongated bar has an elongated intermediate portion, said space being defined in either of the upstream region and the downstream region, said intermediate portion extending along the elongation of the bar between the upstream region and the downstream region, said electric heating means comprising at least one electric heating member.

The invention relates to a method for determining at least one production parameter of a workpiece to be produced, a production method for producing a workpiece, a computer-readable storage medium, and a design system.

Amorphous metals are a new class of materials which have physical properties or combinations of properties that cannot be realized in other materials. The term “amorphous metals” refers to metal alloys that do not have a crystalline structure but an amorphous structure on the atomic level. The amorphous atomic arrangement that is unusual for metals results in unique combinations of physical properties. Amorphous metals are generally harder, more corrosion-resistant and stronger than conventional metals, and are at the same time highly elastic. There are thus no different surface potentials, so that no corrosion can arise.

Metallic glasses have been the subject of extensive research ever since they were discovered at the California Institute of Technology. Over the years, it was possible to continuously improve the processability and the properties of this material class. While the first metallic glasses were still simple, binary alloys (composed of two components), the production of which required a cooling rate in the range of 106 Kelvin per second (K/s), newer, more complex alloys can be converted into the glassy state at significantly lower cooling rates in the range of a few K/s. This has a significant influence on process management and the workpieces that can be produced. The cooling rate from which crystallization of the melt ceases to apply and the melt solidifies in the glassy state is referred to as the critical cooling rate. The critical cooling rate is a system-specific variable which is strongly dependent on the composition of the melt, and which moreover defines the maximum achievable component thicknesses. Considering that the thermal energy stored in the melt must be removed quickly enough by the system, it is clear that only workpieces with a small thickness can be produced from systems with high critical cooling rates. Initially, metallic glasses were therefore for the most part produced according to the melt spinning method. In this case, the melt is stripped onto a rotating copper wheel and solidifies in a glass-like manner in the form of thin strips or films with thicknesses in the range of a few hundredths to tenths of a millimeter. With the development of newer, more complex alloys with markedly lower critical cooling rates, it is increasingly possible to use other production methods. Today's solid glass-forming metallic alloys can already be converted into the glassy state by casting a melt into cooled copper molds. In this case, the realizable component thicknesses are in the range of a few millimeters to centimeters, depending on the alloy. Alloys of this kind are referred to as bulk metallic glasses (BMG). Nowadays, a large number of such alloy systems are known.

The subdivision of bulk metallic glasses usually takes place on the basis of the composition, wherein the alloying element having the highest proportion by weight is referred to as the base element. The existing systems comprise, for example, noble metal-based alloys such as gold-, platinum- and palladium-based bulk metallic glasses, early transition metal-based alloys such as titanium- or zirconium-based bulk metallic glasses, late transition metal-based systems based on copper, nickel or iron, but also systems based on rare earths, for example neodymium or terbium.

Bulk metallic glasses typically have the following properties compared to traditional crystalline metals:
higher specific strength, which enables, for example, thinner wall thicknesses,
higher hardness, whereby the surfaces can be particularly scratch-resistant,
much higher elastic stretchability and resilience,
thermoplastic formability and
higher corrosion resistance.

Due to their advantageous properties, such as high strength and the absence of solidification shrinkage, metallic glasses, in particular bulk metallic glasses, are very interesting construction materials which are suitable in principle for the production of components in series production methods such as injection molding, without further processing steps being mandatory after shaping. In order to prevent crystallization of the alloy during cooling from the melt, a critical cooling rate must be exceeded. However, the greater the volume of the melt, the slower the cooling of the melt (with otherwise unchanged conditions). If a certain sample thickness is exceeded, crystallization occurs before the alloy can solidify amorphously.

In addition to the excellent mechanical properties of metallic glasses, unique processing options also result from the glassy state. Thus, metallic glasses can be shaped not only by metallurgical melting processes, but also by thermoplastic molding at comparatively low temperatures in a manner analogous to thermoplastic plastics or silicate glasses. For this purpose, the metallic glass is first heated above the glass transition point to then behave like a highly viscous liquid which can be formed at relatively low forces. After forming, the material is again cooled below the glass transition temperature.

In the processing of amorphous metals, the natural crystallization is prevented by rapid cooling (freezing in the molten state) of the melt so that the atoms lose their mobility before they can assume a crystal arrangement. Many properties of crystalline materials are influenced or determined by faults in the atomic structure, which are known as lattice defects (gaps, shifting, grain boundaries, phase boundaries, etc.).

As a result of the rapid cooling, the shrinkage of the material is reduced so that more precise component geometries can be achieved in amorphous metals. Plastic deformation only takes place with elongations above 2%. In comparison, crystalline metallic materials show irreversible deformation at significantly lower elongations (<0.5%). Moreover, the combination of high yield strength and high elastic elongation results in a high elastic energy storage capacity.

However, the thermal conductivity of the material used sets a physical limit to the cooling rate, since the heat contained in the component must be released to the environment via the surface. This leads to limitations in the manufacturability of components and in the applicability of production methods.

Various methods for producing workpieces from amorphous metals are known. It is thus possible to produce workpieces using additive manufacturing methods such as 3D printing. The amorphous properties of the workpiece can be ensured by adjusting the process parameters such as the scan speed, the energy of the laser beam or the pattern to be scanned.

One advantage of the additive manufacturing technique is that in principle any conceivable geometry can be realized. Furthermore, it may be advantageous that, in the case of additive manufacturing methods, no separate cooling process is necessary, since effective cooling can be ensured by the layer-by-layer production of the workpiece and by setting the size of the melt pool via the laser energy and scan path of the laser.

A disadvantage of additive manufacturing methods is the low build-up rates at the time of the application, especially for large-dimensioned workpieces. Furthermore, high-purity powder material must be used as the starting material for the additive manufacturing process. If impurities are present in the material, crystallization can occur at the locations of the impurities, resulting in non-amorphous metal, which can lead to a deterioration in the mechanical and chemical properties. It may be necessary to finish the surface of the workpiece due to the impurities, which is complicated. In addition, additive manufacturing always results in a certain roughness on the surface of the workpiece, so that in most cases it has to be finished by grinding or milling.

A further production possibility is injection molding. In this case, workpiece weights in the range of 80-100 g can be realized at the time of the application. The material to be used is usually heated within approximately 20 seconds to approximately 1050° C. by induction heating and is homogenized.

After heating, the molten material is pressed into a mold by means of a punch. It is important for the material properties that when the mold is completely filled with material, the material within the mold should have a temperature above the material melting point throughout. In order to achieve amorphous material properties, the liquid material within the mold must subsequently be cooled rapidly to below the glass transition temperature.

The possible geometries in injection molding are limited to wall thicknesses of 0.3-7.0 mm due to the cooling rate of the material. In the case of larger wall thicknesses, the cooling rate is too low, so that crystalline structures form before the material has cooled to below the glass transition temperature. With smaller wall thicknesses, the material cools too quickly depending on the length to be filled and solidifies before the mold is completely filled.

The production of amorphous metals is difficult. A detailed knowledge of the alloy to be used for a specific workpiece is thereby required. What requirements the workpiece will be subjected to must also be known. Moreover, the production method that is used has a great influence on whether the desired component geometry with the desired properties can be achieved at all. Users without specific preparatory training are therefore unable to produce corresponding components in the desired quality.

It is known from the prior art to simulate the properties of workpieces, for example by means of a finite element method. For example, the behavior of workpieces in different load cases with predetermined materials may thereby be assessed. The mechanical properties may be deduced from the behavior. Moreover, by means of a simulation of the heat profile, it is also possible to assess whether amorphous properties occur in a workpiece after production. It is a disadvantage of these methods that the execution of a simulation of a workpiece is very laborious. The user must therefore wait for a very long time until they have an assessment as to whether a workpiece to be produced possesses the desired properties given a predetermined production method and a given alloy.

The specification of the alloy to be used and the production method also requires expert knowledge. As stated above, different production methods do not always lead to amorphous properties in the produced workpiece. Thus, it is on the expert to assess which production methods are suitable for which component geometry. Moreover, an interaction exists between the production method, the workpiece geometry and the alloy, so that a first alloy leads to an amorphous property given a selected production method, and a specific workpiece geometry leads to an amorphous property given a first production method. However, in the configuration, a second alloy will not lead to amorphous properties. But the second alloy could lead to amorphous properties in the produced workpiece if another production method is selected.

The interaction of the individual parameters is therefore complex and not comprehensible to a layman. The economic use of amorphous metals is thus reserved only for users with expert knowledge, or the production of a workpiece will lead to a large amount of waste.

Proceeding from the cited disadvantages in the prior art, it is therefore the object of the invention to simplify the production of workpieces having amorphous properties. It is in particular the object of the invention to enable the production of workpieces with amorphous properties, even for laypeople. It is also in particular an object of the invention to ensure amorphous properties in a workpiece to be produced. It is also in particular an object of the invention to reduce the waste in the production of workpieces with amorphous properties. It is also in particular an object of the invention to accelerate the production of workpieces with amorphous properties.

The object is achieved by a method for determining at least one production parameter of a workpiece to be produced according to claim 1, by a production method for producing a workpiece according to claim 11, by a computer-readable storage medium according to claim 12, and by a design system according to claim 13.

The object is achieved in particular by a method for determining at least one production parameter of a workpiece to be produced having amorphous properties, the method comprising the following steps:
receiving a component description which specifies a workpiece to be produced;
determining a reference component for at least part of the component description, wherein the determination is performed using pattern recognition;
reading out first simulation data, in particular from a database unit, which specify at least one property of the reference component;
determining at least one production parameter for producing the workpiece using the first simulation data.

Within the scope of this application, the presence of amorphous properties in a workpiece means that this workpiece has (material) structures which lead to amorphous properties, in particular an amorphous, i.e., non-crystalline, structure. In particular, the presence of amorphous properties in an alloy within the scope of this application may mean that the alloy has a proportion of at least 70% amorphous structures, preferably 80% amorphous structures, particularly preferably at least 95% amorphous structures.

A core of the invention is to be able to dispense with the simulation of production processes of the workpiece to be produced, or the like, via the use of existing simulation data of reference components. Thus, without a laborious simulation of the workpiece to be produced, it may be ensured before the actual production that the finished workpiece has amorphous properties. The method thereby goes beyond the mere determination of amorphous properties. Rather, the method determines at least one production parameter with which amorphous properties may be ensured in a workpiece to be produced.

A component description may be specified by a data structure. For example, a component description may be specified by a CAD file. However, it is also possible that the component description is implemented via a data structure of a programming language. The component description may, for example, specify a geometry of a workpiece, for example of the workpiece to be produced and/or of a reference component. A geometry may specify the dimensions of the workpiece, for example. At least one material, for example an alloy, of a workpiece may also be specified by a component description. A component description may also specify a complex workpiece, wherein the complex workpiece may be composed of a plurality of individual workpieces. In particular, the connection points between individual workpieces of a complex workpiece may be specified by a component description.

In one embodiment, the method may comprise the determination of the reference component a segmenting of the component description into a plurality of component segments, wherein the pattern recognition is performed for at least one component segment.

Individual components of a workpiece to be produced may be recognized via a segmentation of the component description. Component segments may thus be recognized via segmentation. A component segment may specify an individual workpiece of a complex workpiece and/or partial segments of a single workpiece. For example, a first component segment may specify a threaded portion of a screw, and a second component segment may specify a screw head. The segmentation may thus, for example, be performed taking into consideration the geometry of the workpiece to be produced. The segmentation may also be performed taking into consideration materials and/or material properties of individual segments of the component description. The materials and/or material properties of individual segments of the component description may be specified by the component description.

In one embodiment, the pattern recognition may associate a reference component with a component segment. For the associated reference component, the first simulation data may be read out in order to determine the at least one production parameter.

The pattern recognition may be designed as a classification. The classes of the classification may thereby be formed by different component types. A component type may likewise be associated with a reference component, so that a reference component may be associated with the workpiece to be produced or with the component segment via a matching of the component type of the reference component with the component type of the workpiece to be produced or of the component segment of the workpiece to be produced. Moreover, the matching of the type of the workpiece to be produced or of a component segment may be used as preselection in order to determine a plurality of candidate reference components from which the reference component is selected by means of the further pattern recognition.

With the above-described embodiments, it is thus possible to determine a reference component in an efficient manner so that computing resources are spared.

In one embodiment, a/the segmentation may comprise dividing a component geometry specified by the component description, using basic shapes and/or connection points.

Basic shapes may, for example, be designed as geometric basic shapes such as cuboids, spheres and/or pyramids. However, it is likewise conceivable that basic shapes or prototypes specify components, for example a prototypical screw and/or also prototypical pincers. The segmentation of a workpiece into basic shapes may normally be implemented very efficiently. It is advantageous here that a plurality of basic shapes may be generated in an automated manner, for example by varying the parameters such as the height, width and depth in a cuboid or the diameter in a sphere. It is thus very efficiently possible to construct a large database with a plurality of basic shapes.

In one embodiment, the method may comprise training a segmentation unit using reference components, which may optionally each be parts of more complex components, wherein the segmentation may be performed in particular using the segmentation unit.

By training the segmentation unit using reference components, it is possible that the trained segmentation unit deconstructs or segments a workpiece to be produced or the associated component description into just those reference components. It may thus be achieved that all available reference components are always taken into account in the segmentation, whereby optimal segmentation is achieved. Overall, the determination of the at least one production parameter is thus improved.

In one embodiment, the determination of the reference component may comprise loading a reference data set, in particular from a database unit, wherein the reference data set may specify a plurality of reference components, and wherein the determination may comprise selecting the reference component from the reference data set using the pattern recognition.

In one embodiment, the pattern recognition may comprise classification, in particular using an artificial neural network, wherein the classification may associate a reference component, in particular of a/the reference data set, with segments, in particular pixels, voxels, volume elements and/or partial segments, of the component geometry.

A particularly advantageous implementation of the pattern recognition results via the use of a classification. In particular, artificial neural networks have thereby proven to be especially efficient and accurate. Convolutional neural networks are suitable in particular. However, in principle other classification mechanisms are conceivable, such as support vector machines or Bayesian networks. By assigning individual pixels, voxels, volume elements and/or partial segments to individual classes, a particularly simple implementation is specified. The classification of individual volume elements has the advantage that a component description is segmented very finely.

In one embodiment, the first simulation data may specify a cooling rate of the reference component for a predetermined alloy and a predetermined production method.

The cooling rate is decisive for ensuring amorphous properties in the workpiece to be produced. The cooling rate depends both on the alloy that is used and also on the production method. Moreover, the cooling rate depends on the geometry of the reference component. It is also possible that the simulation data specify a cooling rate for each volume element of the reference component depending on the alloy that is used and the production method. It is thus possible to establish which regions of the reference component have amorphous properties given a specific alloy and/or given a specific production method.

In one embodiment, the first simulation data may specify mechanical properties of the reference component for a predetermined alloy, a predetermined production method and/or a cooling rate.

Mechanical properties might be derived from the cooling rate in combination with an alloy and/or a production method. It is thus possible to specify a flexural strength and/or a hardness of the reference component. It is thus possible to obtain very accurate information about the behavior of the reference components from the first simulation data.

In one embodiment, the method may comprise:
simulating a cooling rate of a reference component during production for at least one predetermined alloy, in particular a plurality of predetermined alloys, and at least one predetermined production method, in particular for a plurality of predetermined production methods, preferably simulating the cooling rate of the reference component after an injection procedure in an injection molding process;
storing reference simulation data that specify the simulated cooling rate, in particular in a database unit
wherein the stored reference simulation data may be read out as first simulation data.

The embodiment described above describes an instance in which no simulation data for a reference component are stored for a specific alloy and/or a production method. In this instance, it is necessary to generate simulation data. This simulation may either be performed upstream, before an assessment of a workpiece to be produced, or it may be performed “on-demand,” i.e., when a user wishes to determine the at least one production parameter for a workpiece to be produced. It is thus possible that the at least one production parameter may be determined at any point in time.

In one embodiment, the method may comprise determining at least one mechanical property of the workpiece to be produced using a simulated cooling rate of the reference component, wherein the determination of the at least one production parameter may also be performed using the determined at least one mechanical property.

The mechanical properties may depend significantly on the cooling rate. Advantageous mechanical properties in the workpiece to be produced may occur in particular if a critical cooling rate is exceeded, i.e., amorphous properties are achieved. If these mechanical properties are taken into account in determining the at least one production parameter, it is possible to execute the production of the workpiece to be produced in such a way that the determined mechanical properties are also achieved in the finished workpiece.

In one embodiment, the method may comprise simulating at least one mechanical load case of the workpiece to be produced, by using determined mechanical properties, in particular the determined mechanical properties, wherein associated simulation results may be specified by second simulation data, and the determination of the at least one production parameter may also be performed using the second simulation data.

A mechanical load case may, for example, specify a load test in which the behavior of the workpiece to be produced is simulated given a statically acting force on a force application point of the workpiece to be produced. The bending or breaking of the workpiece may thereby be determined. It is thereby conceivable that the at least one production parameter is selected such that the workpiece to be produced satisfies the load case, for example that it does not result in damage to the workpiece to be produced given a load according to the load case.

With the described embodiment, it is made possible that a user may determine the production parameters before the production in such a way that the workpiece to be produced meets the requirements of the user.

In one embodiment, the simulation of the cooling rate may be performed taking into consideration at least one production method, in particular taking into consideration parameters of a production method, for example a stamping speed, an initial temperature and/or a mold geometry. A stamping speed, an initial temperature and/or a mold geometry may, for example, be parameters of an injection molding process.

The simulation of the cooling rate may be performed very precisely if the parameters of a production method are taken into account in the simulation. It is also advantageous to store the information about the production method as part of the first simulation data. It may thereby be determined how the at least one production parameter must be selected in order to achieve the desired mechanical properties of the component to be produced.

In one embodiment, the at least one production parameter may specify a production method and an associated alloy.

In one embodiment, the determination of the at least one production parameter may comprise selecting a production method with an associated alloy and/or at least one mechanical property.

The at least one production parameter may, for example, be the alloy to be used, a production method to be used, and/or a mechanical property. By selecting a suitable alloy, it may, for example, be ensured in a simple manner that desired mechanical properties are achieved in the component to be produced. In one embodiment, the at least one production parameter may therefore be selected such that the component to be produced corresponds to predetermined requirements.

In one embodiment, a/the simulation of a/the cooling rate and/or of a/the mechanical load case for the workpiece to be produced may be performed taking into consideration at least one property of the reference component.

The simulation of the cooling rate and/or of the mechanical load case may, for example, be performed taking into consideration an alloy and/or the geometric properties of the reference component. The simulation may thus provide more accurate data as to how the reference component will behave, for example given a load case.

In one embodiment, a/the simulation of a/the cooling rate and/or of a/the mechanical load case may only be performed when the stored first simulation data for a reference component do not specify a cooling rate or result data for an identical load case.

It is advantageous if the simulation is performed only when simulation data are not yet present. Unnecessary simulations may thus be prevented and computing resources are spared.

In one embodiment, the reference component may specify a first segment of the workpiece to be produced, and a/the simulation of a cooling rate and/or of a/the mechanical load case may be performed for a second segment of the workpiece to be produced.

It is particularly advantageous if a workpiece to be produced is subdivided into a plurality of component segments, and suitable reference components with corresponding simulation data are present only for some of the component segments. In this event, it is conceivable that only those component segments for which no corresponding reference component is present are simulated. The simulation effort may thus be drastically reduced overall.

In one embodiment, a/the simulation of a/the cooling rate and/or of a/the mechanical load case for a/the second segment of the workpiece to be produced may be performed using simulation data that may be associated with the reference component.

In one embodiment, the first and second segment may be arranged spatially next to one another.

Since the simulation data of a second segment of the workpiece to be produced may access the simulation data of a reference component, or these may be used as input data in the simulation, the simulation as a whole may be performed more precisely.

In one embodiment, the receiving of the component description may be performed via a communication network, in particular via the Internet, preferably using an application programming interface.

It is conceivable that individual method steps performed in a data center and further method steps are performed on a production machine. Communication between the individual components may thereby take place via the Internet. It is also conceivable that the user uploads a component description to a web server by means of a website or application, and this is then forwarded to a program for further processing. The at least one production parameter may then be output to the user via their terminal and/or be provided directly to a production machine.

The object is also achieved in particular by a production method for producing a workpiece, comprising the following steps:
determining at least one production parameter via a method according to any one of the preceding claims,
producing the workpiece using the at least one production parameter.

In one embodiment, the production may comprise selecting a production machine using the at least one production parameter.

In one embodiment, a plurality of production machines may be provided that are each designed to produce workpieces. For example, additively operating production machines, such as 3D printers, or injection molding machines may be provided. With the described embodiment, it is now possible that a production machine is selected so that the requirements for the workpiece to be produced are met, e.g., the achievement of amorphous material properties.

The object is also achieved in particular by a computer-readable storage medium which contains instructions which prompt the at least one processor to implement a method as described above when the instructions are executed by the at least one processor.

Similar or identical advantages as have already been described in conjunction with the above method are produced.

The object is also achieved in particular by a design system comprising the following:
a receiving unit that is designed to receive a component description that specifies a workpiece to be produced;
a determination unit that is designed to determine a reference component for at least part of the component description, wherein the determination unit is designed to perform the determination using pattern recognition;
a database unit that is designed to store first simulation data that specify at least one property of the reference component;
a reading unit that is designed to read out the first simulation data from the database unit;
a parameter determination unit that is designed to specify at least one production parameter for producing the workpiece using the first simulation data.

In one embodiment, the determination unit may also be designed to carry out segmentation of the component description into a plurality of component segments, wherein the determination unit may be designed to perform the pattern recognition for at least one component segment.

In one embodiment, the determination unit may be designed to perform a/the segmentation using basic shapes and/or connection points.

In one embodiment, the determination unit may comprise a segmentation unit that may be designed to be trained using reference components that may each be parts of more complex components, wherein the determination unit may also be designed to perform segmentation using the segmentation unit.

In one embodiment, the determination unit may be designed to load a reference data set, in particular from the database unit, wherein the reference data set may specify a plurality of reference components, and wherein the determination unit may be designed to select the reference component from the reference data set using pattern recognition.

In one embodiment, the determination unit may comprise a classification unit which may be designed to associate a reference component, in particular of a/the reference data set, with segments, in particular pixels, voxels, volume elements and/or partial segments, of the component geometry.

In one embodiment, the determination unit may have a simulation unit that may be designed to simulate a cooling rate of a reference component during production for at least one predetermined alloy, in particular a plurality of predetermined alloys, and for at least one predetermined production method, in particular for a plurality of predetermined production methods. The database unit may thereby be designed to store reference simulation data which may specify the simulated cooling rate, wherein the reading unit may be designed to read out the reference simulation data as first simulation data.

In one embodiment, the determination unit may be designed to determine at least one mechanical property of the workpiece to be produced using a/the simulated cooling rate of the reference component, wherein the parameter determination unit may also be designed to perform the determination of the at least one production parameter also using the determined at least one mechanical property.

In one embodiment, a/the simulation unit of the determination unit may be designed to simulate a mechanical load case of the workpiece to be produced, using determined mechanical properties, in particular the determined mechanical properties, wherein associated simulation results may be specified by second simulation data, and the parameter determination unit may also be designed to determine the at least one production parameter also using the second simulation data.

In one embodiment, a/the simulation unit may also be designed to simulate a/the cooling rate taking into consideration at least one production method, in particular taking into consideration parameters of a production method, for example a stamping speed, an initial temperature and/or a mold geometry.

In one embodiment, the parameter determination unit may be designed to select a production method with an associated alloy and/or at least one mechanical property.

In one embodiment, a/the simulation unit may be configured to simulate a/the cooling rate and/or a/the mechanical load case for the workpiece to be produced, taking into consideration at least one property of the reference component.

In one embodiment, a/the simulation unit may be designed to perform a/the simulation of a/the cooling rate and/or of a/the mechanical load case only when the stored first simulation data for a reference component do not specify a cooling rate or result data for an identical load case.

In one embodiment, the reference component may specify a first segment of the workpiece to be produced, and a/the simulation unit may be designed to simulate a/the cooling rate and/or a/the mechanical load case for a second segment of the workpiece to be produced.

In one embodiment, a/the simulation unit may be designed to simulate a/the cooling rate and/or a/the mechanical load case for a/the second segment of the workpiece to be produced, using simulation data that may be associated with the reference component.

In one embodiment, the receiving unit may be designed to receive the component description via a communication network, in particular via the Internet, preferably using an application programming interface.

In one embodiment, the design system may comprise a production machine that may be configured to produce the workpiece to be produced using the at least one production parameter.

Further embodiments arise from the dependent claims. It is explicitly provided that individual aspects which are described in conjunction with the methods may also be combined with the production machine.

The invention is explained in more detail below with reference to exemplary embodiments. In the drawings:

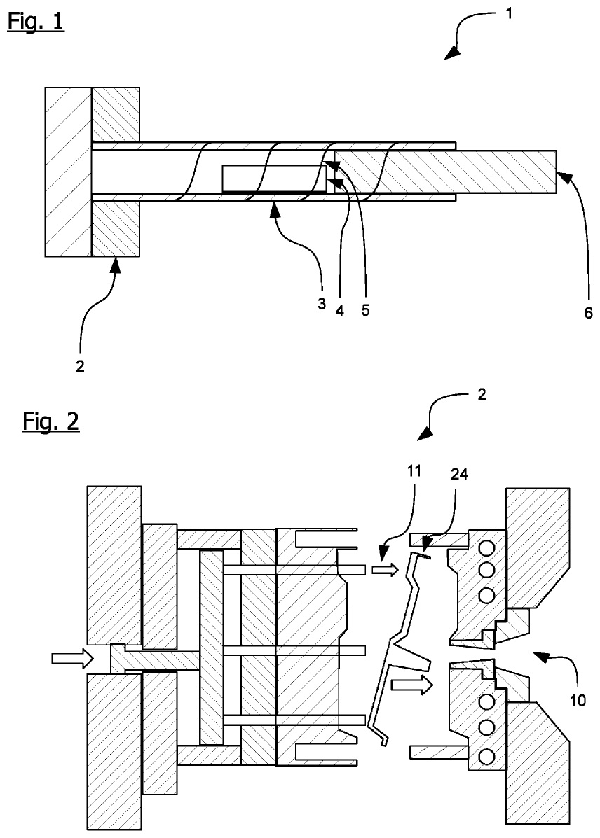

FIG. 1 shows a schematic illustration of an injection molding machine;

FIG. 2 shows a schematic illustration of a tool;

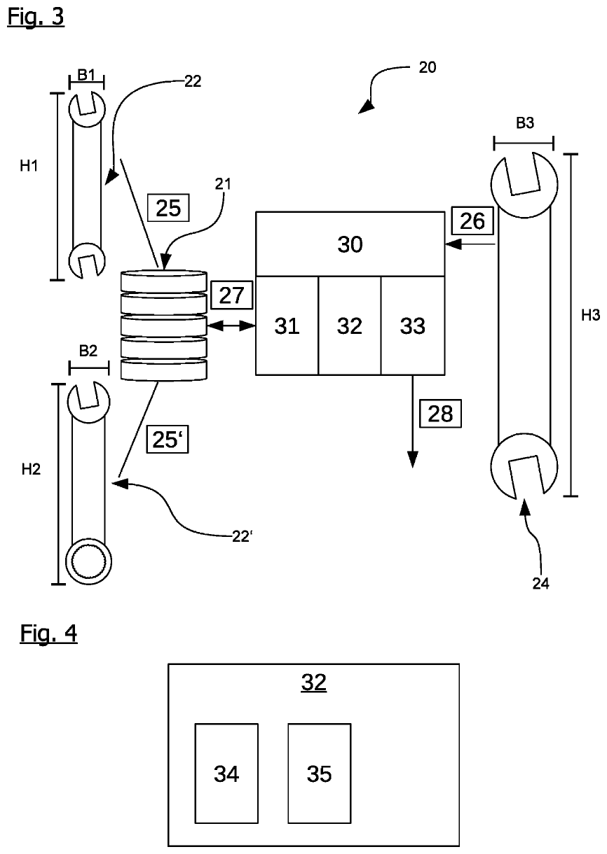

FIG. 3 shows a schematic illustration of a design system;

FIG. 4 shows a schematic illustration of a determination unit;

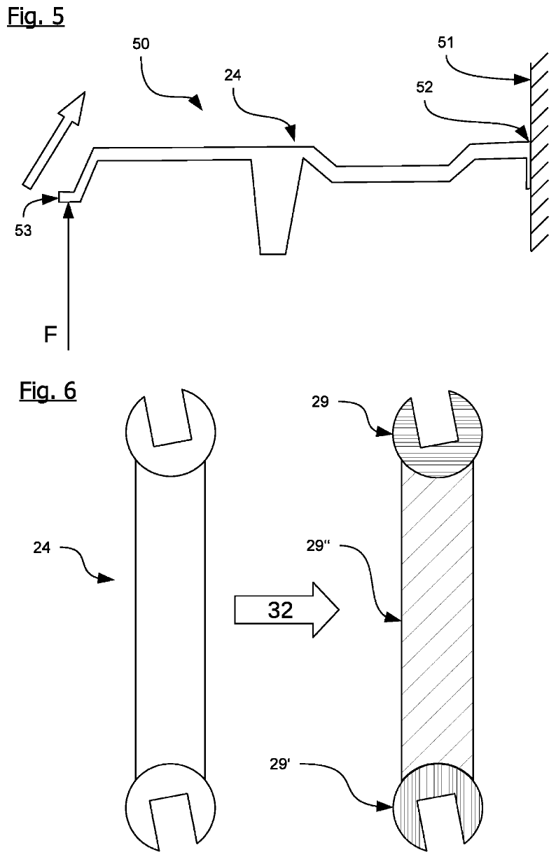

FIG. 5 shows a schematic illustration of a workpiece in a load case;

FIG. 6 shows a schematic illustration of the segmentation of a workpiece;

FIG. 7 shows a schematic illustration of the design of an artificial neural network;

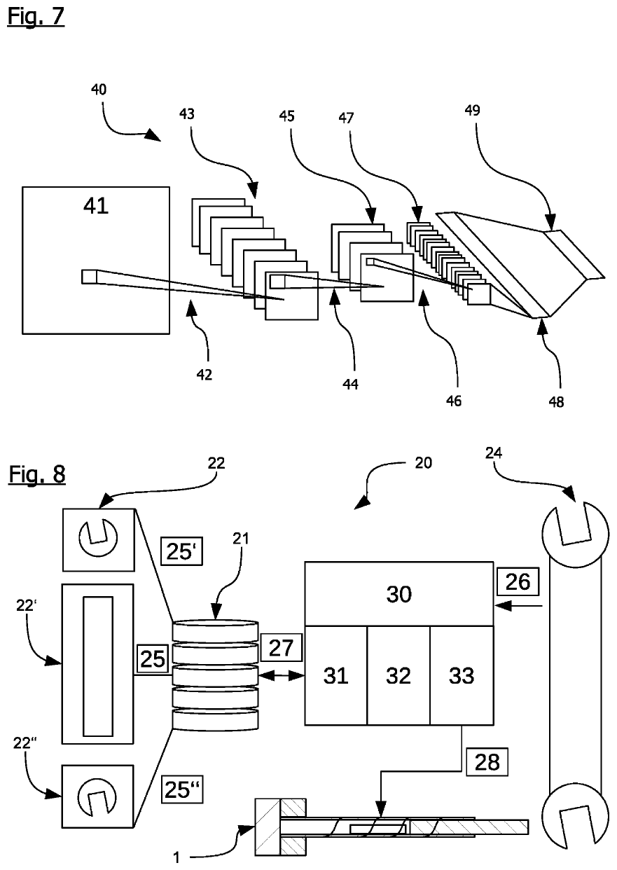

FIG. 8 shows a schematic illustration of a design system in a further exemplary embodiment;

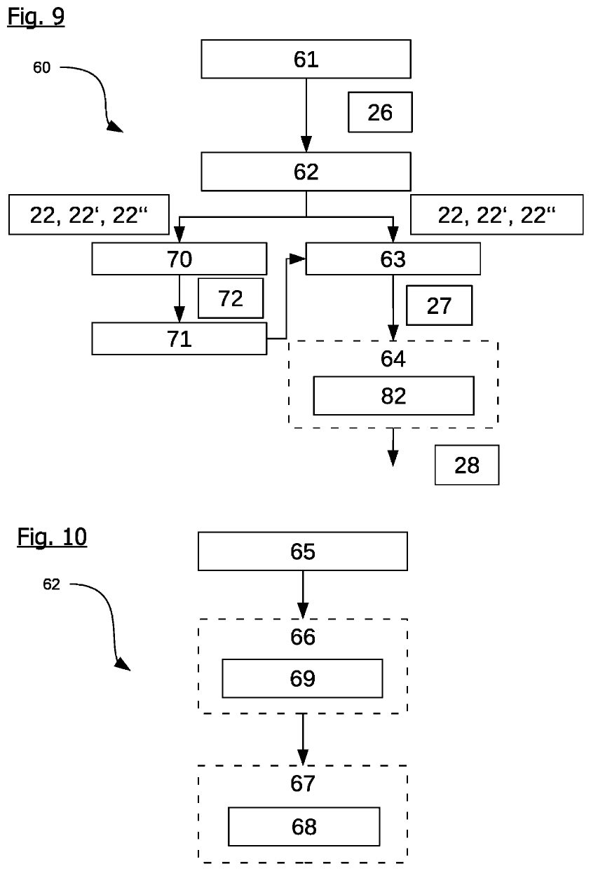

FIG. 9 shows a flow chart for a method for determining at least one production parameter;

FIG. 10 shows a flow chart of method steps for segmenting a workpiece to be produced;

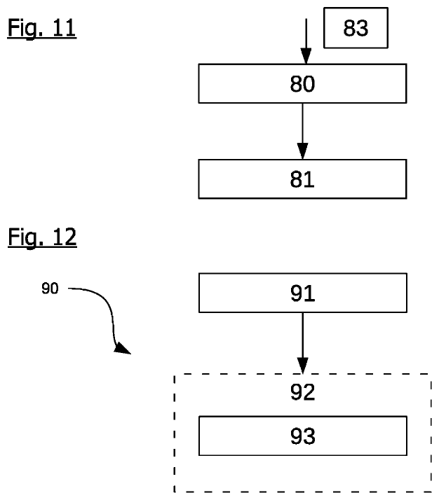

FIG. 11 shows a flow chart for the simulation of a load case;

FIG. 12 shows a flow chart of a production method.

In the following, the same reference numbers are used for identical parts or parts having the same effect.

FIG. 1 shows a schematic representation of an AMM (amorphous metal) injection molding system 1. The injection molding system 1 comprises a mold in the tool 2 and a melting chamber 3. The melting chamber 3 is supplied with a solid alloy segment of an amorphously solidifying alloy (blank) 4 by a robot and is placed centrally in an induction coil 5. The blank 4 is heated within the melting chamber 3 by means of a heating element, in particular an induction field which is generated by the induction coil 5. The blank 4 is a solid alloy segment of an amorphously solidifying alloy. The alloy segment 4 comprises, for example, a certain amount of palladium, platinum, zirconium, titanium, copper, aluminum, magnesium, niobium, silicon and/or yttrium.

The blank 4 is melted by the heating element or the induction coil 5, so that it is present in molten form. Preferably, the blank 4 is heated to a temperature of 1050° C. The molten material is injected into the tool 2 by a piston 6.

FIG. 2 shows the schematic design of an injection molding tool 2. The molding chamber 11 is filled with a melt by means of one or a plurality of openings 10 leading into a molding chamber 11 of a tool 2. The molding chamber 11 is designed as a negative form of the workpiece 24 to be produced. In the exemplary embodiment of FIG. 2, it is provided that an opening 10 can be used to guide liquid material into the molding chamber 11. It can be advantageous to use a plurality of sprues for filling the molding chamber 11 in order to achieve a uniform temperature distribution and to reduce turbulence of the melt. A uniform temperature distribution and a small number of turbulences lead to a better cooling operation, to homogeneous cooling and thus to uniform amorphous material properties.

The liquid material must rapidly cool down within the molding chamber 11 in order to prevent crystallization. The cooling of the liquid material depends greatly on the geometry of the component or workpiece 24 to be produced.

FIG. 3 shows a schematic representation of a design system 20. The design system 20 comprises a database unit 21, a receiving unit 30, a reading unit 31, a determination unit 32, and a parameter determination unit 33.

The receiving unit 30 is designed to receive a component description 26 of a workpiece 24 to be produced. In the exemplary embodiment, the component description is implemented as a CAD file. In the shown exemplary embodiment, the workpiece 24 to be produced is designed as a wrench only by way of example. For simplification, it is assumed that the component description 26 specifies a parameterization of the wrench. The component description 26 thus comprises a height parameter H3 which specifies the height or the length of the workpiece 24 to be produced. Moreover, the component description 26 specifies a width B3 that specifies the width of the workpiece 24 to be produced. Of course, further parameters are conceivable but, however, are omitted for simplification.

In the shown exemplary embodiment, the receiving unit 30 is designed to receive the component description 26 via a communication network. For this purpose, the receiving unit 30 provides a programming interface, for example an API (application programming interface), by means of which user programs may transmit data to the receiving unit 30.

The receiving unit 30 is communicatively connected to the determination unit 32 so that the component description 26 of the determination unit 32 may be provided by the receiving unit 30.

The database unit 21 is designed to store component descriptions 25, 25′ of a plurality of reference components 22, 22′. The reference components 22, 22′ may each be associated with different component types. It may thus be seen in FIG. 3 that the reference component 22 is a wrench, and the reference component 22′ is a ratchet combination wrench. The associated component descriptions 25, 25′ likewise respectively specify geometric parameters B1, B2, H1, H2 of the associated reference components 22, 22′.

Moreover, the database unit 21 is designed to store simulation data 27 associated with the reference components 22, 22′. The simulation data 27 comprise information regarding the production and/or the use of the reference components 22, 22′. In one exemplary embodiment, the simulation data 27 thus comprise cooling rate data for individual segments of the reference components, given production with a selected production method and a selected alloy. The simulation data 27 may additionally or alternatively specify properties of the reference components 22, 22′ derived from the cooling rates. For example, the simulation data 27 specify which component segments of the reference components 22, 22′ have amorphous properties.

The determination unit 32 is designed to determine a reference component using the component description 26 of the workpiece 24 to be produced. For this purpose, the determination unit 32 may be designed to segment the component description 26. The segmentation deconstructs the component description 26 into component segments. These component segments may, for example, be designed as basic geometric shapes such as cuboids, pyramids or balls.

The determination unit 32 is additionally or alternatively designed to deconstruct the component description 26 into component segments that each specify individual components. A complex workpiece may thus be deconstructed into sub-workpieces; for example, a screwed-together, complex workpiece may be broken down into the individual workpieces and the screws.

The determination unit 32 is also designed to determine at least one reference component 22, 22′ using pattern recognition, either for the entire workpiece 24 to be produced or for component segments of the workpiece 24 to be produced. In one embodiment, a type of the workpiece 24 to be produced may first be determined for this purpose. For example, a classifier may be used in order to associate a component type with the workpiece to be produced. Based on the determined component type, the reading unit 31 may read out, from the database unit 21, the reference components 22, 22′ which are associated with the same component type. A preselection may thus be made by means of the component type.

Alternatively, it is also possible that the reading unit 31 is designed to read out reference components 22, 22′ in succession from the database unit 21 in order to thus check whether a reference component 22, 22′ has sufficient similarity to the workpiece 24 to be produced. A regression system or a classifier may be used to establish the similarity. For example, a classifier may have a binary output that is “1” if sufficient similarity is present and “0” if no sufficient similarity is present. A regression system may specify a value of the similarity, wherein a value of “1” may specify that a full identity is present and a value of “0” may specify that there is no similarity between a reference component 22, 22′ and the workpiece 24 to be produced. The parameters stored in the component descriptions 26, 25, 25′ may also be used for determining the similarity.

In the shown exemplary embodiment of FIG. 3, the determination unit 32 determines that the workpiece 24 specified by the component description 26 has a high similarity to the reference component 22. The reading unit 31 is designed to read out simulation data 27 of the reference component 22, 22′ that exhibits the greatest similarity to the component 24 to be produced.

As stated, the simulation data 27 specify, for example, the cooling temperature of the reference component 22 upon production. It may thus be established whether the reference component 22 has amorphous properties.

The parameter determination unit 33 is now designed to specify, using the simulation data 27, at least one production parameter 28 for the workpiece 24 to be produced. The parameter determination unit 33 is thereby designed to use, for example, certain data of the simulation data 27 as production parameters 28 for the workpiece 24 to be produced. For example, if the simulation data 27 specify that the associated reference component 22 has amorphous properties, the parameter determination unit 33 may thus specify the alloy simulated in the reference component 22 and the simulated production method as production parameters 28 for the workpiece to be produced. It may thus be ensured, without a new simulation, that the workpiece 24 to be produced will also have amorphous properties.

FIG. 4 shows a schematic view of a determination unit 32. The determination unit 32, in the shown exemplary embodiment, has a classification unit 34 which is designed to determine whether a reference component 22, 22′ is suitable as a basis for determining the at least one production parameter 28 for the workpiece 24 to be produced. As was already stated above with respect to FIG. 3, the classification unit 34 is designed to determine a similarity of the workpiece 24 to be produced and the reference components 22, 22′ stored in the database unit 21.

Moreover, the determination unit 32 has a simulation unit 35 which is designed to simulate the behavior of the workpiece 24 to be produced or component segments of the workpiece 24 to be produced. The simulation unit 35 is, for example, designed to simulate the temperature behavior during production for a production method and an alloy. It may thus be established whether amorphous properties are achieved with the selected alloy and the production method for the workpiece to be produced, i.e., whether the cooling rate is greater than a critical cooling rate.

Moreover, the simulation unit 35 is designed to simulate load cases of the workpiece 24 to be produced.

FIG. 5 thus shows a schematic representation of a load case 50. In the load case 50, a workpiece 24 is attached to a wall 51 at a distal end 52. The workpiece 24 is free at a proximal end 53. The application of a force F perpendicularly from below at the proximal end 53 of the workpiece 24 is now specified by the load case 50. The application of the force F leads to a deformation of the workpiece 24. A torque, i.e., a bending moment, thereby acts on the workpiece 24 so that deformation occurs. If the force F is too great, either irreversible bending or even breakage of the workpiece 24 occurs.

The simulation unit 35 is now designed to simulate the behavior of the workpiece 24 upon application of the force F. Associated simulation data 27 thus specify how much the workpiece 24 bends and/or whether breakage occurs. The simulation data 27 may thereby also specify a time profile, i.e., the state of the workpiece 24 at different points in time after the application of the force F at the proximal end 53.

FIGS. 6 to 8 show a further exemplary embodiment of the design system 20.

FIG. 6 illustrates the segmentation of a workpiece 24 into component segments 29, 29′, 29″. As described, the determination unit 32 is designed to deconstruct a workpiece 24 to be produced into individual component segments 29, 29′, 29″. For this purpose, the determination unit 32 may be implemented as an artificial neural network 40; cf. FIG. 7. In the exemplary embodiment of FIG. 6, the workpiece 24 to be produced is a wrench. The workpiece 24 to be produced is in this case segmented into three component segments 29, 29′, 29″. A first component segment 29 is formed by a first end which comprises first jaws arranged parallel to one another. A second component segment 29′ is formed by the second end of the wrench 24, which has two jaws arranged parallel to one another and is arranged so as to be horizontally mirrored to the first component segment 29. A third component segment 29″ is arranged between the first and the second component segment 29, 29′ and comprises a grip area of the wrench 24.

In order to segment the workpiece 24 to be produced, the determination unit 32 may process the component description 26 which specifies the workpiece 24 to be produced. For segmentation, a neural network may be used, for example, which associates the individual component segments with a class of objects. For example, the artificial neural network of FIG. 6 may be used for this purpose.

FIG. 7 shows an artificial neural network which, in the instance of FIG. 6, is designed as a convolutional neural network 40 (CNN 40). The neural network 40 of FIG. 7 can be designed as a classifier or as a regressor.

Input data 41 for the neural network 40 may be a tensor, i.e., a three-dimensional matrix, which has a plurality of data elements. Each data element can correspond to a volume element. Each data element can be designed as a tuple which indicates whether material is present at the location of the corresponding volume element, what material is used, and/or what initial temperature prevails at the location of the corresponding volume element. The component description 26 of the workpiece 24 to be produced may, for example, be designed as a three-dimensional tensor 41 with volume elements. The component description 26 may thus specify the input data 41 of the neural network 40.

However, it is also conceivable that the component description 26 is designed as a CAD model which parameterizes basic shapes such as curves, cuboids, spheres and others. The elements of the CAD model may thus also form the input data 41. In this instance, too, when the input data 41 are thus specified by the elements of a CAD model, the elements of the CAD model may be expressed as a tensor in order to form the input data 41.

A CCN 40 is defined by a plurality of parameters. A kernel sequentially scans the input data 41 in a first step. The stride of the kernel indicates by how many volume elements the kernel must be shifted during each scan. The size of the kernel can also be defined. The stride and the size of the kernel thus define the so-called feature detectors 43 which are generated by a first convolution 42. Each feature detector 43 detects a specific feature in the input data 41. For example, a feature detector 43 may indicate whether or not material is present at a particular location. Overall, a plurality of feature detectors 43 are generated which have not been previously defined manually.

According to the same principle, a new set of feature generators 45 is generated from the first feature detectors 43 in a second convolution 44, wherein during the second convolution the number of feature generators is reduced compared to the first convolution. Such a step is referred to as pooling or subsampling.

A third set of feature generators 47 is generated in a third convolution 46. In the last step, a class is assigned to each volume element by means of a so-called soft-max layer. This means that it is apparent from the output as to which class of objects a volume element belongs. As a result, the segmentation of a workpiece 24 to be produced and the association of the workpiece 24 or of individual component segments 29, 29′, 29″ with reference components 22, 22′, 22″ may be performed in a single step, for example by means of the neural network of FIG. 6.

Each layer of the CCN 40 consists of a large number of neurons, i.e., of activation functions to which weights are assigned. The output of the neuron is activated or not activated depending on the weight and an input value. Possible activation functions include, for example, logit, arc tan, Gaussian functions. Training of the CCN 40 is performed using the backpropagation algorithm, wherein the values of the weights are determined.

There are a number of different models for CNN, such as VGG-net, RES-net, general adversiral networks or google LeNet. Any of these implementations can be used, or another implementation is possible. Training of the neural networks can be carried out efficiently, since a plurality of the operations can be carried out parallelized. The inference, i.e., the querying of values for certain component description, can be carried out very efficiently.

FIG. 8 shows an exemplary embodiment of a design system 20 in which a workpiece 24 to be produced is segmented into a plurality of component segments 29, 29′, 29″, and these may be associated with individual reference components 22, 22′, 22″.

In contrast to the design system 20 of FIG. 1, in the design system 20 of FIG. 8, a component 24 to be produced or the associated component description 26 is received by a receiving unit 30 and segmented by means of the determination unit 32 into individual component segments 29, 29′, 29″.

The database unit 21 stores at least three reference components 22, 22′, 22″ which correspond to the component segments 29, 29′, 29″. The determination unit 32 is designed to identify the reference components 22, 22′, 22″ corresponding to the component segments 29, 29′, 29″.

The reading unit 31 subsequently reads out simulation data 25, 25′, 25″ for the identified reference components 22, 22′, 22″. The parameter determination unit 33 thereby determines at least one production parameter 28, based on the read-out simulation data 25, 25′, 25″, and outputs it to an injection molding machine 1. Alternatively, a machine for producing the workpiece 24 to be produced may also be selected with the production parameter 28 in an upstream step.

In the shown exemplary embodiment, the parameter determination unit 33 is designed to combine the simulation data 25, 25′, 25″ with one another in order to determine the at least one production parameter 28. In this case, the parameter determination unit 33 may use, for example, existing data to simulate a load case for the workpiece to be produced, in order to determine whether the workpiece 24 to be produced withstands the load case on the basis of the simulated behavior of the workpiece 24 to be produced given a predetermined alloy and/or a predetermined production method.

In one exemplary embodiment, the cooling behavior of the reference components 22, 22′, 22″, which is specified by the simulation data 25, 25′, 25″, may be used in order to establish whether the workpiece 24 to be produced has amorphous properties given an alloy that is used and a production method. In this instance, the simulation data of the simulation data 25, 25′, 25″ may be used as input data of a simulation of the cooling process of the workpiece 24 to be produced.

The parameter determination device 33 is designed to decide, based on the simulation data 25, 25′, 25″ and/or a simulation of the workpiece 24 to be produced, whether the result of a production with the simulated production parameters corresponds to a requirement profile. If the result of the production does not correspond to the requirement profile, the simulation of the workpiece 24 to be produced is performed with changing parameters until the requirement profile is fulfilled. Only then are the simulated parameters output as at least one production parameter 28.

In this context, the parameter determination unit 33 may also be designed to perform an optimization of the production parameters with respect to a target value using a cost function. The cooling behavior may thus be used as a cost function which is to be minimized, i.e., the cooling rate is to be maximized. The exceeding of a critical cooling rate which specifies the achievement of amorphous properties may thereby be used as a termination criterion.

FIG. 9 shows a flow chart for a method 60 for determining at least one production parameter 28, which method is implemented by the design system 20. In a receiving step 61, a component description 26 is received which specifies a workpiece 24 to be produced. In a determination step 62, a reference component 22, 22′, 22″ for the workpiece to be produced is determined, as was already explained in conjunction with FIGS. 3 and 8. For the reference component 22, 22′, 22″, a cooling rate may subsequently be simulated 70. In the simulation 70, reference simulation data 72 are generated which are stored in a database unit 21 in a subsequent storage step 71.

The reference simulation data 72 and simulation data 27 stored regarding the specific reference component 22, 22′, 22″ are subsequently read out from the database unit 21 in a readout step 63. Using the simulation data 27 or the reference simulation data 72 which may be portions of the simulation data 27, at least one production parameter 28 for the component to be produced is now determined in a determination step 64 according to the principles already described above. In the shown embodiment, the determination 64 of the at least one production parameter 28 comprises selecting 82 a production machine 1 with which the workpiece 24 to be produced is to be produced.

FIG. 10 shows a flow chart of the use of a determination unit 32. In a first training step 65, a classification and/or regression unit 34 is trained or taught. For this purpose, in the shown exemplary embodiment, the supervised learning method is used. The trained classification or regression unit 34 is used in a segmentation step 66 to segment the workpiece 24 to be produced. The segmentation 66 thereby comprises a dividing step 69 in which the workpiece 24 to be produced is divided into component segments 29, 29′, 29″ (cf. FIG. 6).

In a pattern recognition step 67, a check is subsequently made, by means of the same or a further classification or regression unit 34, in a pattern recognition step 67, as to which reference component 21, 21′, 21″ stored in a database unit 21 has a sufficient similarity to the workpiece 24 to be produced. A reference component 22, 22′, 22″ is thereby associated with each component segment 29, 29′, 29″ in a classification step 68.

FIG. 11 illustrates how, in a determination step 80, at least one mechanical property of the workpiece 24 to be produced is determined. The determination 80 is thereby performed using a simulated cooling rate 83. For example, an amorphicity value which may specify the degree of amorphicity may be determined using the simulated cooling rate 83.

Based on the at least one mechanical property, a load case 50 is now simulated in the subsequent simulation step 81, as is explained in more detail in conjunction with FIG. 5. A check may thereby be made as to whether the workpiece 24 to be produced would withstand the load case 50 with the simulated parameters.

FIG. 12 shows a flow chart of a production method 90. In a first step 91, at least one production parameter 28 is determined for a workpiece 24 to be produced, as described in detail above. Using the determined at least one production parameter 28, the workpiece 24 to be produced may subsequently be produced by means of a production machine 1.

It is explicitly pointed out that all described aspects may be combined with one another in any manner. In particular, the aspects described with respect to devices are likewise disclosed for the corresponding methods, and vice versa.

### LIST OF REFERENCE SIGNS

1 Injection molding machine

2 Tool

3 Melt cylinder

4 Alloying element/blank

5 Heating element

6 Punch

10 Inlet opening

11 Molding chamber

20 Design system

21 Database unit

22, 22′, 22″ Reference component

24 Workpiece

25, 25′, 25″ Component description of a reference workpiece

26 Component description of the workpiece to be produced

27 Simulation data

29, 29′, 29″ Component segments

28 Production parameter

30 Receiving unit

31 Reading unit

32 Determination unit

33 Parameter determination unit

34 Classification unit

35 Simulation unit

40 Artificial neural network

41 Input data/tensor

42 First convolution

43 Feature detector

44 Subsampling

45 Second feature detectors

46 Second convolution

47 Third feature detectors

48 Feed-forward layer

49 Output layer

50 Load case

51 Wall

52 Distal end

53 Proximal end

60 Method

61 Receiving step

62 Determination step

63 Readout step

64 Determination step of a production parameter

65 Training

66 Segmentation

67 Pattern recognition

68 Classification

69 Division

70 Simulation of cooling rate

71 Storage

72 Reference simulation data

80 Determination step

81 Simulating a mechanical load case

82 Selection

83 Simulated cooling rate

90 Production method

91 Determining at least one production parameter

92 Production

93 Selecting a production machine

F Force

B1, B2, B3 Width

H1, H2, H3 Height

1. A method for determining at least one production parameter of a workpiece to be produced that has amorphous properties, said method comprising the following steps:
simulating a cooling rate of a reference workpiece during the production for at least one predetermined alloy and at least one predetermined production method, taking into consideration at least one production method;
storing reference simulation data that specify the simulated cooling rate;
receiving a component description that specifies a workpiece to be produced, wherein the component description is specified by a data structure, and wherein the component description specifies a geometry of the workpiece to be produced and an alloy;
determining a reference component for at least part of the component description, wherein the determination is performed using pattern recognition , wherein the determination of the reference component comprises segmenting the component description into a plurality of component segments, wherein the pattern recognition is performed for at least one component segment;
reading out first simulation data for the reference component that specify at least one property of the reference component, wherein the stored reference simulation data are read out as first simulation data;
determining at least one production parameter for producing the workpiece using the first simulation data.

2. The method according to claim 1, wherein the segmentation comprises dividing a component geometry specified by the component description, using basic shapes and/or connection points.

3. The method according to claim 1, wherein the determination of the reference component comprises loading a reference data set, in particular from a database unit, wherein the reference data set specifies a plurality of reference components , and wherein the determination comprises selecting the reference component from the reference data set using the pattern recognition

4. The method according to claim 1, wherein the pattern recognition comprises classification, in particular using an artificial neural network, wherein the classification associates a reference component, in particular of a/the reference data set, with component segments , in particular pixels, voxels, volume elements and/or partial segments of the component geometry.

5. The method according to claim 1, wherein the first simulation data specify a cooling rate of the reference component for a predetermined alloy and a predetermined production method.

6. The method according to claim 1, wherein the first simulation data specify mechanical properties of the reference component for a predetermined alloy, a predetermined production method and/or a cooling rate.

7. The method according to claim 1, wherein the simulation of the cooling rate of the reference workpiece during production is performed for for a plurality of predetermined alloys and for a plurality of predetermined production methods, preferably simulation of the cooling rate of the reference workpiece after an injection procedure in an injection molding process;
and wherein the storing of the reference simulation data comprises storing in a database unit.

8. The method according to claim 1, wherein determining at least one mechanical property of the workpiece to be produced using a simulated cooling rate of the reference component, wherein the determination of the at least one production parameter is also performed using the determined at least one mechanical property.

9. The method according to claim 1, wherein the simulation of the cooling rate is performed taking into consideration parameters of a production method, for example a stamping speed, an initial temperature and/or a mold geometry.

10. The method according to claim 1, wherein the simulation of the cooling rate or of the mechanical load case is only performed when the stored first simulation data for a reference component do not specify a cooling rate or result data for an identical load case.

11. A production method for producing a workpiece, comprising the following steps: determining at least one production parameter via a method according to claim 1, producing the workpiece using the at least one production parameter.

12. A computer-readable storage medium which contains instructions which prompt the at least one processor to implement a method according to claim 1 when the instructions are executed by the at least one processor.

13. A design system, comprising the following:
a receiving unit which is designed to receive a component description that specifies a workpiece to be produced, wherein the component description is specified by a data structure, and wherein the component description specifies a geometry of the workpiece to be produced and an alloy;
a determination unit which is designed to determine a reference component for at least part of the component description, wherein the determination unit is designed to perform the determination using pattern recognition, wherein the determination unit is further designed to perform segmentation of the component description into a plurality of component segments, wherein the determination unit is designed to perform the pattern recognition for at least one component segment, wherein the determination unit has a simulation unit which is designed to simulate a cooling rate of a reference component during production for at least one predetermined alloy and for at least one predetermined production method, taking into consideration at least one production method;
a database unit that is designed to store first simulation data that specify at least one property of the reference component, and wherein the database unit is further designed to store reference simulation data that specify the simulated cooling rate;
a reading unit that is designed to read out the first simulation data for the reference component from the database unit, and wherein the reading unit is further designed to read out the stored reference simulation data;
a parameter determination unit which is designed to determine at least one production parameter for producing the workpiece using the first simulation data.

14. The design system according to claim 13, wherein a production machine that is designed to produce the workpiece to be produced using the at least one production parameter.
